(19) United States
(12) Patent Application Publication
(10) Pub. No.: US 2007/0288685 A1
(43) Pub. Date: Dec. 13, 2007

(54) FLASH MEMORY SCATTER-WRITE METHOD

(75) Inventor: Chien-Hua Chu, Chutung Town, Hsinchu Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: PHISON ELECTRONICS CORP., Chutung Town, Hsinchu Hsien (TW)

(21) Appl. No.: 11/423,148

(22) Filed: Jun. 9, 2006

(51) Int. Cl. G06F 12/00

(52) U.S. Cl. 711/103

(57) ABSTRACT

A flash memory scatter-write method divides a physical block of a flash memory into two areas, the first area includes a plurality of sub areas, and the second area is an area containing no data and provided for alternately writing data. If a data is written into a flash memory, a physical block in a non-predetermined sub area is selected from the first area first, and then a desired write-in physical block in the second area is selected, such that if the number of times of writing data at that particular time is a multiple of a predetermined value, then the write-in physical block is changed to another physical block in the second area for writing data, and then the data in the selected physical block of the first area is written into the physical block of the second area, and the selected physical block of the first area is moved to the second area, and the physical block of the second area containing the written data is moved to the first area, so as to scatter the number of times of writing data in each block and extend the life of the flash memory.

### BACKGROUND OF THE INVENTION

1. Field of the Invention

The present invention relates to a flash memory scatter-write method, and more particularly to a data write-in method that changes the desired physical block to scatter the number of times of writing data in each block, so as to extend the life of a flash memory.

2. Description of Related Art

Since the flash memory has been introduced, the flash memory with its charming features such as low power consumption, non-volatility, shock resistance, and high storage capacity gradually replaces the EEPROM or battery power supply memory of many portable devices. Since the present semiconductor technology advances day after day and the storage density and transmission rate of the flash memory are enhanced rapidly, therefore many applications of the flash memory can replace traditional storage media such as hard disk drive. However, the access method of the flash memory is restricted by its structural design, and a page is used as a unit for reading data, and any address in a page can be used as a starting position for reading data. If it is necessary to write data, a block will be used as a unit, and the entire block will be erased first, and then data will be written page by page. Therefore, there is a restricted structure of the flash memory for accessing data, when the data with a capacity of less than a block is processed.

A general flash memory usually comes with a low-level format, so that each physical block address in the flash memory can be written into a corresponding logical block address to create a correct mapping table for the logical block address and the physical block address. However, a logical block maps into one or more physical blocks, such that when a data is written repeatedly into certain logical blocks or alternately into certain physical blocks, the data will be centralized into certain write-in areas, and thus reducing the life of the flash memory. Referring to FIGS. 5 and 6 for the schematic block diagrams of writing data according to a prior art, the flash memory is divided into a first area A1 and a second area A2, and the first area A1 is a logical area containing data, and the second area A2 is an area containing no data, and the second area A2 is provided primarily for writing data alternately, so that when data is written into the flash memory, a desired write-in physical block A21 is selected from the physical blocks of the second area A2, and then the data is written into the physical block A21. After the data is written into the physical block A21, the physical block A21 is moved to the first area A1 to replace the physical block A11, and the physical block A21 is changed to a block in the first area A1 containing the data, and the physical block A11 is moved into the second area A2 and changed to an area containing no data. However, this method only changes the data in some blocks of the first area A1 that causes data to be written alternately in some blocks of the first area A1 and the physical block A21 of the second area A2. Writing data in these blocks so frequently not only causes an uneven number of times of writing data in each block, but also results in a poor memory management and a short life of the flash memory.

Therefore, finding a way to provide a better flash memory management in hope of enhancing the system performance, extending the life of the flash memory, and reducing the power consumption of the system is a subject for related manufacturers to study and make improvements.

### SUMMARY OF THE INVENTION

In view of the foregoing shortcomings and deficiencies, the inventor of the present invention based on years of experience in the related industry to conduct extensive researches and experiments, and finally invented a flash memory scatter-write method in accordance with the present invention.

Therefore, it is a primary objective of the present invention to divide a physical block of a flash memory into a first area and a second area, and the first area includes a plurality of sub areas, and the second area is an area containing no data and provided for alternately writing in data. If a data is written into the flash memory, a physical block in a non-predetermined sub area is selected from the first area first, and then a desired write-in physical block in the second area is selected, such that if the number of times of writing data at that particular time is a multiple of a predetermined value, then the write-in physical block is changed to another physical block in the second area for writing data, and then the data in the selected physical block of the first area is written into the physical block of the second area, and the selected physical block of the first area is moved to the second area, and the physical block of the second area containing the written data is moved to the first area, so as to scatter the number of times of writing data in each block and extend the life of the flash memory.

### BRIEF DESCRIPTION OF THE DRAWINGS

FIG. 1 is a block diagram of a preferred embodiment of the invention.

FIG. 2 is a block diagram of writing data according to a preferred embodiment of the invention.

FIG. 3 is a block diagram of writing data according to another preferred embodiment of the invention.

FIG. 4 is a flow chart of writing data according to a preferred embodiment of the invention.

FIG. 5 is a schematic block diagram of a prior art write-in method.

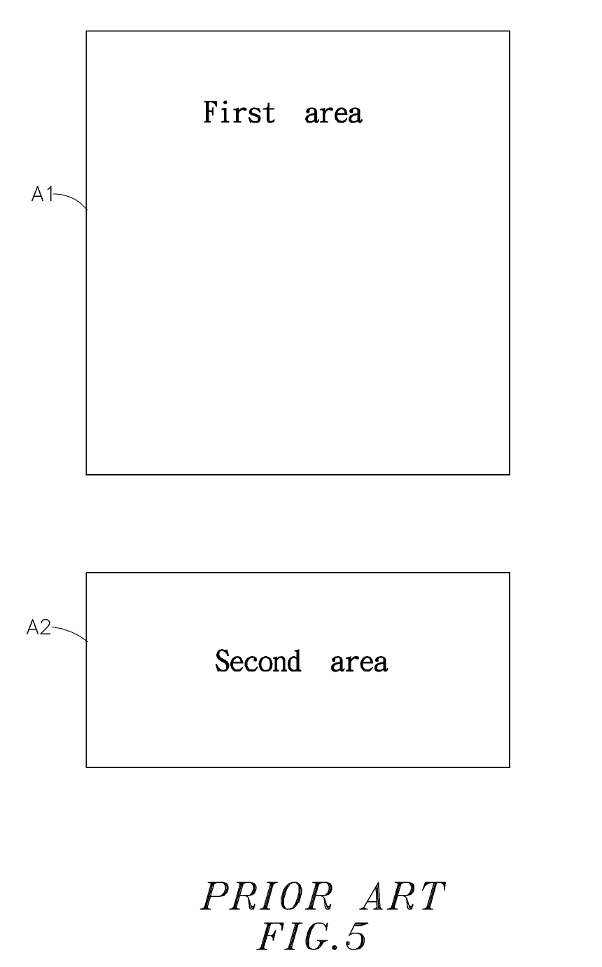

FIG. 6 is another schematic block diagram of a prior art write-in method.

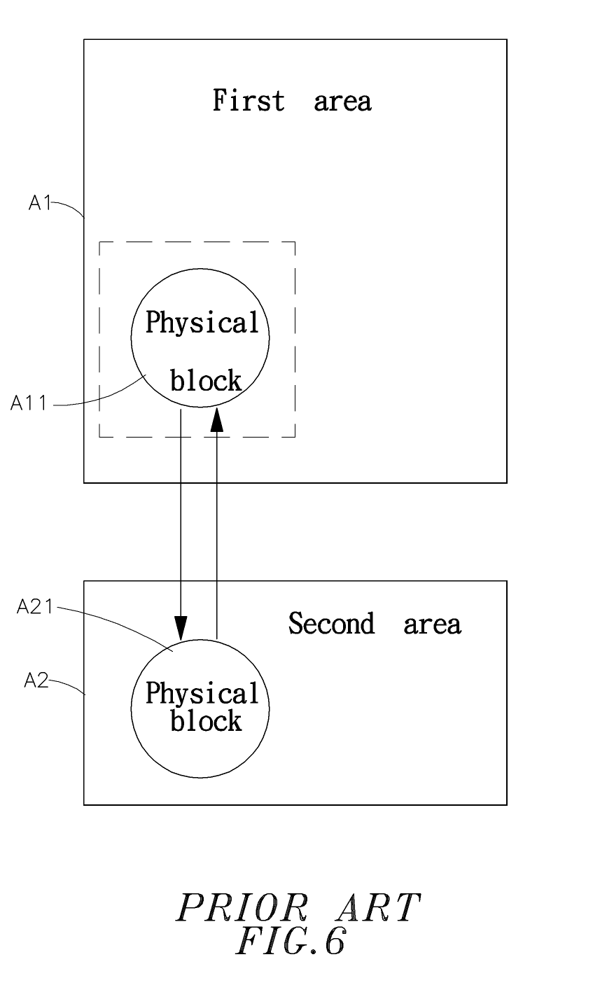

### DETAILED DESCRIPTION OF THE PREFERRED EMBODIMENTS

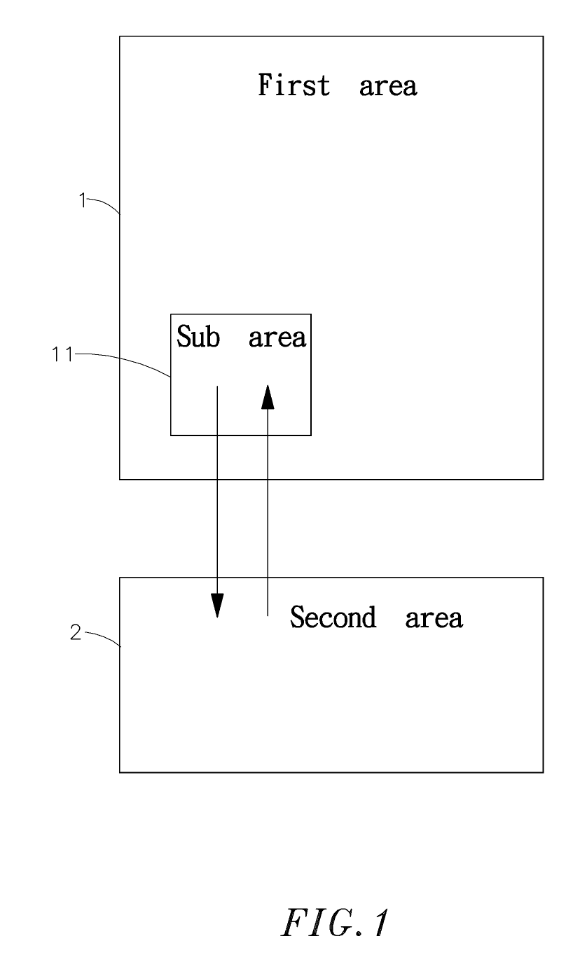

Referring to FIG. 1, a flash memory scatter-write method of the invention divides a physical block of a flash memory into a first area 1 and a second area 2.

The first area 1 is an area containing data, and the first area 1 comprises a plurality of sub areas 11, and each sub area 11 includes a plurality of physical blocks 111.

The second area 2 is an area containing no data and primarily provided for alternately writing data, and the second area 2 comprises a plurality of physical blocks 21.

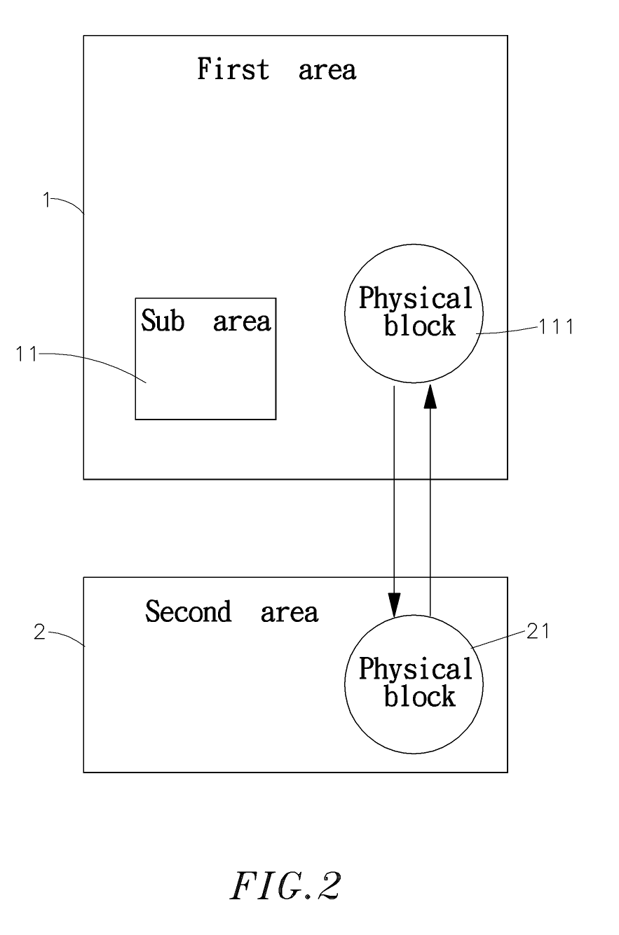

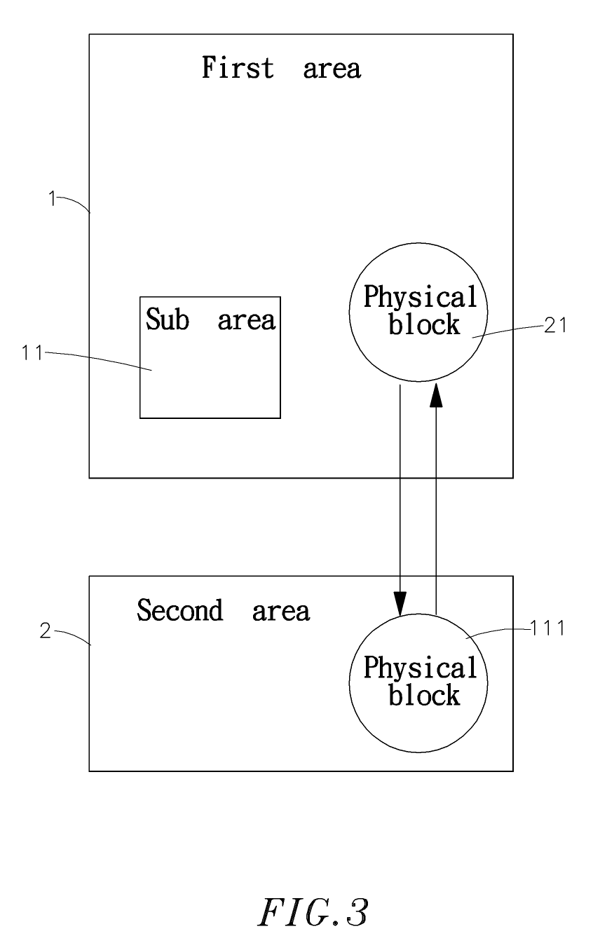

Referring to FIGS. 2 and 3, when a data is written into the flash memory, a predetermined sub area 11 is selected from a plurality of sub areas 11 of the first area of a flash memory, and a physical block 111 is selected from another non-predetermined sub areas 11, and a physical block 21 is selected in the second area 2 as a physical block 21 for writing data, and then the number of times of writing data into the flash memory at that particular time is determined whether or not it is a multiple of a predetermined value. If the number of writing data in the flash memory at that particular time is a multiple of the predetermined value, then the desired write-in physical block 21 selected from the second area 2 is changed to another physical block 21 as a physical block 21 of the second area 2 for writing data. If the number of times of writing data into the flash memory at that particular time is not a multiple of the predetermined value, then it is not necessary to change the write-in physical block 21 of the second area 2. After the physical block 111 of the first area 1 and the physical block 21 of the second area are selected, then the data in the selected physical block 111 of the first area 1 is written into the physical block 21 of the second area 2. After the data is written, the selected physical block 111 of the first area 1 is moved to the second area 2. In the meantime, the physical block 21 of the second area 2 containing the written data is moved to the first area 1. After the selected physical block 111 of the first area 1 is moved to the second area 2, the selected block 111 will become a physical block 21 of the second area 2, and after the physical block 21 of the second area 2 containing the written data is moved to the first area 1, the physical block 21 becomes a physical block 111 of the first area 1.

If the number of times of writing data into the flash memory reaches a multiple of a predetermined value, the physical block 21 of the second area 2 will be renewed, so as to evenly scatter the number of times of writing data into the physical block 111 of the first area 1 and the physical block 21 of the second area 2, and thus improving the life of the flash memory. Therefore, the present invention can overcome the shortcomings of the prior art of which only a fixed number of physical blocks of the flash memory can be used for writing data alternately, and resulting in an uneven number of times of writing data in each block, and causing a poor memory management.

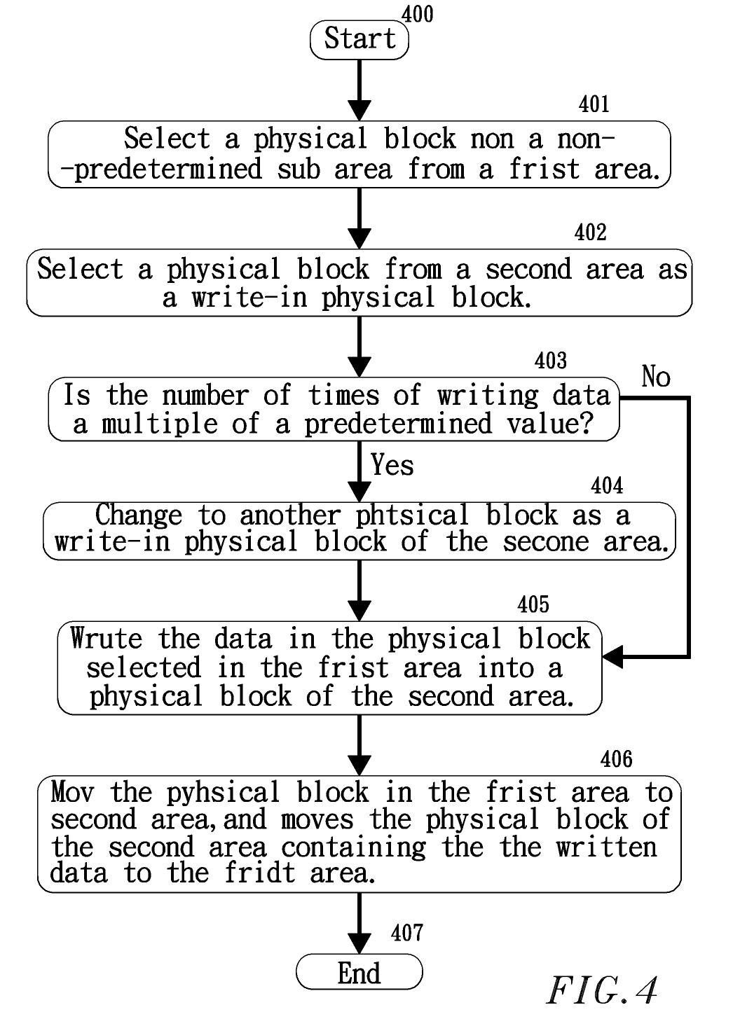

Referring to FIG. 4, the process of writing data according to the invention comprises the steps of as following.

At step 400, starting the process.

At step 401, selecting a physical block 111 from a non-predetermined sub area 11 of a first area 1.

At step 402, selecting a physical block 21 from a second area 2 as a write-in physical block 21.

At step 403, determining whether or not that particular time of writing data is a multiple of a predetermined value; if yes, then execute Step 404; if no, then execute Step 405.

At step 404, changing another physical block 21 as a write-in physical block 21 of the second area 2.

At step 405, writing the data in the selected physical block 111 of the first area 1 into the physical block 21 of the second area 2.

At step 406, moving the selected physical block 111 of the first area 1 to the second area 2, and moving the data written in the physical block 21 of the second area 2 to the first area 1.

At step 407, ending the process.

In summation of the description above, the flash memory scatter-write method of the present invention has the following advantages.

If the number of times of writing data reaches a multiple of a predetermined value, the desired write-in physical block 21 selected by the second area 2 is changed to another physical block 21 as a physical block 21 of the second area 2 for writing data, so that the flash memory can renew the physical block 21 of the second area 2 once for every certain number of times of writing data. The present invention not only scatters the number of times of writing data into the physical block 111 of the first area 1 and the physical block 21 of the second area 2, but also extends the life of the flash memory effectively.

While the invention has been described by means of specific embodiments, numerous modifications and variations could be made thereto by those skilled in the art without departing from the scope and spirit of the invention set forth in the claims.

What is claimed is:

1. A flash memory scatter-write method, dividing a physical block of a flash memory into a first area and a second area, and said first area being a logical area containing data, and said first area comprising a plurality of sub areas, and said second area being an area containing no data and used for alternately writing data, such that data is written into said flash memory according to a procedure comprising the steps of:
(A) selecting a physical block in a non-predetermined sub area from said first area;
(B) selecting a physical block from said second area as a write-in physical block;
(C) determining whether or not the number of times of writing data at that particular time is a multiple of a predetermined value; if yes, then execute Step (D), and if no, then execute Step (E);
(D) changing to another physical block as a physical block of said second area for writing data;
(E) writing the data contained in said selected physical block of said first area into said physical block of said second area; and
(F) moving said selected physical block of said first area to said second area, and moving said physical block of said second area containing the written data to said first area.

2. The flash memory scatter-write method of claim 1, wherein after said selected physical block of said first area is moved to said second area, said selected physical block becomes a physical block of said second area.

3. The flash memory scatter-write method of claim 1, wherein after said physical block of said second area containing the written data is moved to said first area, said physical block becomes a physical block of said first area.
